(19) United States
(12) Patent Application Publication
(10) Pub. No.: US 2025/0011608 A1
(43) Pub. Date: Jan. 9, 2025

(54) SILYL FUNCTIONAL CELLULOSIC RHEOLOGY MODIFIERS FOR SILANES IN CONSTRUCTION APPLICATIONS

(71) Applicants: Dow Global Technologies LLC, Midland, MI (US); Dow Silicones Corporation, Midland, MI (US)

(72) Inventors: Marc-Andre Courtemanche, Midland, MI (US); Jean-Paul Lecomte, Brussels (BE); Matthew Mclaughlin, Midland, MI (US); Sabrina Salvati, Mons (BE); Beata A. Kilos, Midland, MI (US)

(21) Appl. No.: 18/709,944

(22) PCT Filed: Nov. 21, 2022
(86) PCT No.: PCT/US2022/050521

§ 371 Date: May 14, 2024

Related U.S. Application Data
(60) Provisional application No. 63/283,694, filed on Nov. 29, 2021.

(51) Int. Cl. C09D 7/63; C08K 5/5419; C09D 101/02

(52) U.S. Cl. CPC C09D 7/63; C08K 5/5419; C09D 101/02

(57) ABSTRACT

The present invention provides thickened hydrolyzable organosilane, such as alkoxyalkyl silane compositions that comprise an alkylsilyl group-containing cellulose thickener having a weight average molecular weight of from 60 to 5000 kDa, such as a trialkylsilyl cellulose. The compositions may comprise neat hydrolyzable organosilanes and from 0.1 to 5 wt. %, based on the total weight of the composition, of the alkylsilyl group-containing cellulose. The compositions having a viscosity resembling paint or coating compositions and are suitable for use as treating or coating compositions that confer water resistance to cementititious substrates.

### FIELD

The present invention relates to hydrolyzable organosilane compositions thickened with a cellulosic polymer for use in limiting the water sensitivity of construction materials, such as those made from hydraulic cement. More particularly, it relates to compositions of hydrolysable organic oxysilanes, such as alkoxysilanes, thickened with an alkylsilyl group-containing cellulose having a weight average molecular weight of at least 60,000 daltons and their application to substrates comprising concrete or surfaces of hydraulic setting materials, such as cement, mortar, renders and plaster.

### INTRODUCTION

Construction materials such as concrete, fiber cement boards, and others can absorb water over time. Water absorption by these materials can negatively impact the structural integrity and mechanical performance of these materials. Therefore, these and similar materials have been treated with hydrophobic surface treatment agents so that water will wash off the surface of the material or so as to reduce the water uptake by a given material.

Some hydrolyzable silanes, especially oxysilanes comprising a hydrophobic group or side-chain, may provide effective hydrophobicizing agents for use with construction materials. The hybrid nature of, for example, an alkoxysilane allows the alkoxy functionality therein to bind to an inorganic material, while the hydrophobic nature of the silane provides desirable water resistance. However, such alkoxysilanes cannot form a strong film on their own; and their low viscosity makes their application in the field difficult. For example, applications in the field to vertical surfaces, such as concrete barriers or bridging structures, requires multiple treatments with alkoxysilane materials because they have a low viscosity and, after runoff an insufficient amount of the material remains on the surface to penetrate due to this runoff. As a result, applications must be applied on sequential days. Further, the spray application of low viscosity silanes would be considered hazardous, requiring highly protective and cumbersome safety equipment; and, their low viscosity means that brushing or roller application of, for example, alkoxysilanes remains infeasible. This is to say nothing of the hazards caused by the runoff itself.

Previously, disclosures have revealed that silanes, as non-polar solvents, may be thickened by at least four known methods: Suspended fillers, in-situ polymerization of vinyl monomers, such as (alkyl)acrylates, waxes and cellulose ethers. However, all known thickening methods leave much to be desired. Fillers, such as bentonite clay and talc require use at relatively high loadings to achieve low to moderate thickening, forming at best turbid solutions, and usually only suspensions after long periods of mixing; and the extra solids can interfere with performance-in application. In-situ polymerization requires a high monomer loading; and the cure chemistry may not be compatible with hydrolyzable silanes. Waxes, such as ester or polyhydrocarbon waxes, offer low thickening efficiency and the risk of phase separation from a lack of compatibility, especially in non-hydrocarbon-containing silane formulations. Cellulose ethers comprise polar molecules, which limits their use to thickening materials more polar than hydrolysable silanes; and for the same reason they have failed to prove useful to thicken silanes.

Other gelled hydrophobicizing silane containing materials have been made available for use in construction applications. Such materials either are thickened with clays or are provided as inverse emulsions, such as water-in-oil emulsions. However, both clay thickened compositions and water-in-oil emulsions can have undesirable effects on a final substrate undergoing hydrophobicizing treatment.

More recently, various efforts have been made to modify polysaccharides, for example, hydroxyethyl cellulose (HEC), with siloxane electrophiles, such as the reaction of hydroxyethyl cellulose (HEC) with 3-(aminopropyl)triethoxysilane. The resulting polymer was disclosed for direct formulation into a hair dye. However, no yield information about the polymer was made available; and it remains unclear if or how such a polymer would find a suitable use in hydrophobicizing construction materials, much less whether it would actually work in such a use. In addition, cationic cellulose modified with aminosilane compounds, such as 3-(aminopropyl)triethoxysilane, have been disclosed with the advantage of easier dispersion and dissolution. However, cationic cellulose generally fails to provide suitable surface treatments because they are highly hygroscopic. Thus, it remains unclear if or how such materials find a suitable use in construction applications. Another part of the problem lies in the fact that any organic composition comprising a silicon atom may contaminate an entire facility using it; and, to date, no construction material production facility is fully committed to making only organic silicon containing materials. It would be desirable to find a way to make a hydrophobicizing organic silicon containing material suitable for downstream construction use, including by industrial customers, wherein the material is readily and effectively used in construction applications or that can be applied to existing structures at the site of use.

US patent no. U.S. Pat. No. 5,410,037A, to Wagner et al., discloses a trimethylsilylated cellulose (TMSC) fiber made by functionalizing a fiber to improve the chemical or mechanical stability of the article in which the cellulose fiber is used. The product TMSC fiber finds use as a structural enhancement. Wagner discloses that the fiber can be solubilized in some organic solvents. However, the fibers themselves cannot confer water resistance to an entire structure or protect it from water uptake. In fact, no art discloses any TMSC or other silylated cellulose in a composition suitable for surface treatment of construction materials.

The present inventors have sought to enable the provision of a hydrolysable silane suitable for ready use as a water resistance conferring treating agent for application to construction substrates in the field, such as fiberboards.

### SUMMARY

In accordance with the present invention a composition suitable for use as a coating or a treating composition comprises:
one or more hydrolysable organosilanes comprising at least one hydrolysable group, such as an alkoxy group, and at least one alkyl group, such as a haloalkyl group, or aryl group, preferably, at least one C₁ to C₁₂ alkyl group; and,
a rheology modifier comprising an alkylsilyl group-containing cellulose, such as a triorganosilyl cellulose, preferably, a trimethylsilylcellulose,
wherein the composition has a viscosity at 25° C. of from 50 to 2000 centistokes (cSt or m²/s) or, preferably, from 100 to 1000 cSt (mm²/s). The composition may comprise:
from 90 to 99.9 wt. % or, preferably, from 95 to 99.9 wt. % or, more preferably, from 97 to 99.8 wt. % in total of one or more hydrolyzable organosilanes having a viscosity at 25° C. of from 0.2 to 20 cSt (mm²/s), or, preferably, from 0.2 to 10 cSt (mm²/s), and having a formula weight (FW) of from 89 to 500 g/mol, for example, 300 g/mol or less, preferably, wherein at least one organosilane comprises an alkoxy group; and,
from 0.1 to 10.0 wt. %, or, preferably, from 0.1 to 5 wt. %, or, more preferably, from 0.2 to 3 wt. % of an alkylsilyl group-containing cellulose having a degree of alkylsilyl group substitution (DS) ranging from 0.8 to 3.0, or 1.0 to 3.0, or, preferably, 1.5 or higher, and, further, having an average molecular weight of from 60 to 5,000 kDa, or, preferably, from 85 to 1,500 kDa, wherein all components add up to 100 wt. %. The alkylsilyl group-containing cellulose comprises a silyl ether (Si—O—C) bond on any hydroxyl group of the cellulose, and the alkylsilyl group has the formula —Si(R¹)₃, wherein each R¹ group may independently be chosen from an aryl group, hydrogen, or an alkyl group, such as a C₁ to C₈ alkyl groups or a haloalkyl group, preferably, a C₁ to C₄ alkyl group; or more preferably, three alkyl groups; and, further wherein, at least one R¹ group is other than hydrogen or an aryl group.

The one or more hydrolyzable organosilanes may be any alkoxyalkylsilane having one or more C₁ to C₁₂ alkyl groups and at least one alkoxy group, preferably, two or more alkoxy groups, or, preferably, one or more C₁ to C₈ alkyl groups and at least one C₁ to C₄ alkoxy group. Examples of preferred alkoxyalkylsilanes may be chosen from a methyl trimethoxysilane, an octyl triethoxysilane, an isobutyl triethoxysilane, or a mixture thereof.

In another aspect, the present invention provides a method of coating or treating a cementitious substrate, such as concrete or a cement fiber board, with the composition in accordance with the present invention, comprising applying the composition to the substrate, for example, by spraying, applying with a roller, squeegee, or brush.

### DETAILED DESCRIPTION

In accordance with the present invention, efficiently thickened hydrolyzable organosilane compositions comprise an alkylsilyl group-containing cellulose, such as a trialkylsilyl cellulose. The compositions of the present invention enable application of an increased amount of the hydrophobic silanes to construction materials in a single pass, without waste or deleterious effects to their performance or visual appearance. Preferably, the alkylsilyl group-containing cellulose comprises a trimethylsilylcellulose, which also acts as a film-former. The alkylsilyl group-containing cellulose can thicken a variety of silanes, including, for example, oxysilanes suitable for treating substrates and materials comprising hydraulic cements. The alkylsilyl group-containing cellulose can be used at low concentrations without negatively impacting the ability of silanes containing them to improve the water resistance of construction materials, for example, concrete or cement fiber boards. The alkylsilyl group-containing cellulose compositions are relatively stable and easy to make. For example, trimethylsilyl cellulose (TMSC), can be formed by a simple substitution of hydroxyl groups on cellulose by a silylating agent, such as hexamethyl disilazane, in the presence of a hydrogen donating reagent, such as ammonium chloride. Further, the TMSC is resistant to hydrolysis by both water or water vapor even though it comprises silane groups attached to the cellulose via an Si—O—C linkage. In fact, when a TMSC composition was submerged in water at 27° C. for 120 hours, less than 10% hydrolysis was observed, based on the total number of Si—O—C linkages. Further, in boiling water, it has taken more than 24 hours to fully desilylate the TMSC. The alkylsilyl group-containing cellulose compositions of the present invention can thicken a variety of silanes at very low use levels, such as from 0.1 to 1 wt. %, based on the total weight of a given composition, without impacting their ability to hydrophobicize concrete or cement fiber boards. Common hydrolyzable organosilanes including trialkoxyalkylsilanes, such as methyltrimethoxysilane, isobutyltriethoxysilane and octyltriethoxysilane can be thickened. The thickened hydrolyzable silane containing compositions allow application of a thick surface treatments that do not run off the surface of a substrate. The composition may also form a film upon full penetration and drying of the treatment on the surface to further enhance the water resistant performance of the compositions.

Unless otherwise indicated, conditions of temperature and pressure are room temperature (23° C.) and standard pressure (101.3 kPa), also referred to as “ambient conditions”. And, unless otherwise indicated, all conditions include a relative humidity (RH) of 50±10%.

Unless otherwise indicated, any term containing parentheses refers, alternatively, to the whole term as if parentheses were present and the term without them, and combinations of each alternative. Thus, as used herein the term, “(meth)acrylate” and like terms is intended to include acrylates, methacrylates and their mixtures.

The singular forms “a,” “an,” and “the” include plural referents unless the context clearly dictates otherwise. Unless defined otherwise, the terms used herein have the same meaning as is commonly understood by one skilled in the art.

All ranges recited are inclusive and combinable. For example, a disclosed degree of alkylsilyl group substitution (DS) ranging from 0.8 to 3.0, or 1.0 to 3.0, or, preferably, 1.5 or higher includes each of a DS of from 0.8 to 3.0, or, from 1.0 to 3.0, or, from 0.8 to 1.0, or, preferably, 1.5 or higher or, preferably, from 1.5 to 3.0.

As used herein, the term “ASTM” refers to publications of ASTM International, Conshohocken, Pa.

As used herein, the term “ISO” refers to the publications of the International Organization for Standardization, Geneva, CH.

As used herein, unless otherwise indicated, the term “formula weight” or “FW” refers to the molecular weight of the representative formula of a given material expressed in g/mol, regardless of its polydispersity or any isomers present. For example, methyltrimethoxysilane has an FW of 136 g/mol.

As used herein, the term “polymer” refers, in the alternative, to a polymer made from one or more different monomer, such as a copolymer, a terpolymer, a tetrapolymer, a pentapolymer etc., and may be any of a random, block, graft, sequential or gradient polymer.

As used herein, the term “total solids” or “solids” means all materials in a given composition aside from solvents, unreactive volatiles, including volatile organic compounds or VOCs, ammonia and water. Solids generally include film-formers, polymers, surfactants and pigments.

As used herein, unless otherwise indicated, the term “weight average molecular weight” or “MW” refers to the weight average molecular weight as measured by gel permeation chromatography (GPC), using conventional standards, such as polyethylene glycol standards. These techniques are discussed in detail in Modem Size Exclusion Liquid Chromatography: Practice of Gel Permeation and Gel Filtration Chromatography, Second Edition, Striegel, et al., John Wiley & Sons, 2009. Weight average molecular weights are reported herein in units of Daltons.

As used herein, the phrase “wt. %” stands for weight percent.

In accordance with the present invention, cellulose thickened silane compositions comprise a mixture of one or more silanes, for example, a hydrolysable organosilane or oxysilane, such as an alkoxy silane, and a cellulose containing organosilyl groups, such as alkylsilyl groups. Thus, the present inventors have succeeded in dissolving or at least partly dissolving the silylated cellulose ether in a pure/neat silane, enabling the silylated cellulose ether to act as a thickener. The compositions unexpectedly provide a viscous, shear-thinning, transparent solution which has the capability of forming hydrophobic films upon penetration into the surface and drying which are suitable to render construction materials more water-resistant by simple surface application without excessive runoff of the composition from the material substrate. The compositions form a thick solution in the organosilane that can be readily rolled or sprayed onto a substrate. The compositions of the present invention comprise:
from 95 to 99.9 wt. % or, preferably, from 95 to 99.9 wt. % or, more preferably, from 97 to 99.8 wt. %, in total of one or more hydrolyzable organosilanes having a viscosity at 25° C. of from 0.2 to 20 cSt (mm²/s), or, preferably, from 0.2 to 10 cSt (mm²/s), and having a formula weight (FW) of from 89 to 500 g/mol, wherein at least one organosilane comprises a hydrolysable group, or is, preferably, an alkoxyalkylsilane, such as a C₁ to C₁₂ alkyl group containing C₁ to C₄ alkoxysilane; and,
from 0.1 to 5.0 wt. % or, preferably, from 0.1 to 5 wt. %, or, more preferably, from 0.2 to 3 wt. %, of an alkylsilyl group-containing cellulose having a degree of substitution (DS) ranging from 0.8 to 3.0, or 1.0 to 3.0, or, preferably, 1.5 or higher, and has an average molecular weight of from 60 to 5,000 kDa, or, preferably, from 85 to 1,500 kDa, wherein all wt. % s add up to 100%. Suitable as the one or more hydrolyzable organosilanes are, for example, any commonly available alkoxyalkylsilanes. A hydrolysable silane may comprise any of a low molecular weight (less than 500 g/mol), low viscosity (less than 20 cSt or less than 20 mm²/s at 25° C.) silane. Alkyl groups bring some hydrophobic behavior; further, bulkier or longer chain alkyl groups may increase the “hydrophobic” character of the silane. The silane may contain alkoxy groups and may contain other functional groups such as esters, carboxylic acids, alcohols, or aromatic groups. The hydrolysable groups, such as alkoxy groups, on the silane facilitate chemical bonding of the silane to construction materials, such as hydraulic cements and cement fiber boards. The preferable alkylalkoxysilanes may be chosen from, for example, a methyl trimethoxysilane, an octyl triethoxysilane, an isobutyl triethoxysilane or mixtures thereof.

Suitable as the alkylsilyl group-containing cellulose may be a trialkylsilyl group containing cellulose having a degree of alkylsilyl group substitution (DS), or molar equivalents per glucose unit or saccharide ring) of 0.8 or greater. The alkylsilyl group-containing cellulose may comprise, for example, a trimethylsilyl group-containing cellulose. The alkylsilane substituent —OSiR¹ on the cellulose may have an R¹ chosen independently from an alkyl group, such as a C₁ to C₈ alkyl group or a haloalkyl group; anaryl group; or hydrogen. Depending on the organic group(s) on the one or more hydrolyzable organosilanes used, the alkylsilyl group-containing cellulose may have a lower DS and be more soluble in or compatible with the silane. For example, where both the silane and the silyl group on the cellulose comprise a methyl, ethyl or C₆ to C₁₂ alkyl group, preferably, where both comprise at least one of the same alkyl group, such as methyl, the alkylsilyl group-containing cellulose may have a DS of, for example, 1.0 to 2.5.

The alkylsilyl group-containing cellulose of the present invention may be made by conventional methods, such as those disclosed in US patent no. U.S. Pat. No. 5,410,037A, to Wagner et al. The weight average molecular weight (MW) of the starting cellulose used to make the alkylsilyl group-containing cellulose may range from 50 to 1,500 kDa and will form polymers having an MW of at least 60 kDa. For example, the alkylsilyl group-containing cellulose may comprise a cellulose functionalized with three —SiR¹ groups, wherein the resulting cellulose has a weight average molecular weight of 60,000 to 5,000,000 Daltons. In the formula —SiR¹, each R¹ may independently be chosen from a hydrogen; an alkyl group, such as a C₁-C₁₂ alkyl group, or a C₁-C₈ haloalkyl group; an aryl group; a C₁-C₈ alkylaryl group, such as a C₁-C₈ haloalkylaryl group, or, preferably, a C₁-C₈ alkyl group; more preferably, at least one C₄-C₈ alkyl group and one or more C₁-C₂ alkyl groups.

The thickening alkylsilyl group-containing cellulose may have a weight average molecular weight of, preferably, from 90,000 to 1,400,000 Daltons, or, more preferably, from 95,000 to 1,300,000 Daltons, or, most preferably, from 100,000 to 1,000,000 Daltons.

The compositions of the present invention may have a viscosity at 25° C. of from 50 to 2000 cSt (mm²/s), or of from 80 to 1200 cSt (mm²/s), or, preferably, from 100 to 1000 cSt (mm²/s).

Compositions of the present invention may comprise an aqueous emulsion further comprising water and one or more surfactants, such as a nonionic surfactant, such as, for example, a block copolymer of ethylene oxide and propylene or butylene oxide, or a colloidal stabilizer like poly(vinyl alcohol). In such compositions, the relative amounts of the alkylsilyl group-containing cellulose may be increased to from 0.5 to 20 wt. %, such as from 0.5 to 10 wt. %, or, from, 0.8 to 10 wt. %, or, up to 5 wt. %, or 1 wt. % or more, based on the total weight of the one or more hydrolyzable organosilanes and the alkylsilyl group-containing cellulose, wherein all wt. % s add up to 100%. The amount of water in such compositions may comprise up to 60 wt. %, or up to 50 wt. %, based on the total weight of the compositions, wherein all wt. % s add up to 100%. Such compositions may have the same overall viscosity as neat thickened hydrolyzable organosilane compositions and may be easier to handle for brush or roller application.

The compositions of the present invention may further comprise one or more conventional auxiliary additives, such as colorants, antioxidants, humectants or wetting agents, emulsifiers or other materials commonly used in water proofing agents, and combinations thereof.

In another aspect, the present invention provides a method of treating a cementitious substrate, such as concrete or a cement fiber board with the composition in accordance with the present invention. The method comprises applying the composition to the substrate, for example, by spraying, applying with a roller, squeegee, or brush. The thickness of the resulting coating or treating may range from, for example, 0.5 to 5 mm, or from 1 to 5 mm. Once applied, the compositions generally dry in from 8 to 48 hours.

For substrates that may prove more difficult to treat, such as, for example, vertical or especially smooth surfaces, a film, such as of a shear plastic or polymer material may be applied over the treatment as it dries.

### Examples

The following examples illustrate the present invention. Unless otherwise indicated, all temperatures are ambient temperatures (21-25° C.), all pressures are 1 atmosphere and relative humidity (RH) is 50%±10%. Notwithstanding that the numerical ranges and parameters setting forth the broad scope of the invention are approximations, numerical values set forth in the specific examples are reported as precisely as possible. Any numerical value inherently contains certain errors necessarily resulting from the standard variation found in their respective testing measurements.

The materials used in the Examples are defined, below. Abbreviations used in the examples include: Da: Daltons; DS: Degree of Substitution; FW: Formula weight; MW: Weight Average Molecular weight.

The following materials were used in the Examples that follow:
Ammonium chloride: Reagent≥99.5 wt. %, Sigma-Aldrich, St. Louis, Mo (Sigma-Aldrich);
Cellulose 1: E60 cellulose MW 100,000; GP Cellulose, Georgia-Pacific LLC, Atlanta, GA (GP);
Dimethyl sulfoxide: ≥99.9 wt. % anhydrous (Sigma-Aldrich);
Hexamethyldisilazane, Dow Incorporated, Midland, MI (Dow):
Methyltrimethoxy silane: Z-6070 silane, Dow;
Octyltriethoxy silane: Z-6341 silane, Dow;
Isobutyltriethoxy silane: Z-6403 silane, Dow;
TMSC 1: Trimethylsilyyl cellulose made in Synthesis Example 1, DS 2.3.
TMSC 2: Trimethylsilyyl cellulose made in Synthesis Example 2, DS 2.2.

The Degree Of Alkylsilyl Group Substitution (DS) in the alkylsilyl group-containing celluloses TMSC 1 and TMSC 2 was determined using well known techniques based on Attenuated Total Reflection—Fourier Transform Infrared Spectroscopy, and analyzing the indicated peak areas of the resulting spectra by calculating using MATLAB™ software (Mathworks, Portola Valley, CA) and plugging in the spectral parameters provided in Table 1A, below.

TABLE 1A
FTIR Spectral Peaks for Trimethylsilyl Cellulose

| | |
|---|---|
| Integration (cm⁻¹) | Baseline (cm⁻¹) |

| Species | Start | End | Start | End |
|---|---|---|---|---|
| —Si(CH₃)₃ | 1277 | 1220 | 1278 | 1219 |
| —OH | 3685 | 3033 | 3697 | 3040 |

The DS values for TMSC 1 and TMSC 2 were determined to be DS=2.3 and DS=2.2, respectively.
Silane 1: Caprylyl trimethicone: DOWSIL™ FZ-3196 Fluid: caprylyl branched trisiloxane (CH₃)₃Si—O—Si(CH₃)(C₈H₁₇)—O—Si(CH₃)₃, 0.65 cSt (m²/s) (Dow);
Silane 2: Phenyl trimethicone: 556 fluid (Dow);
Cyclic siloxane 1: Octamethylcyclotetrasiloxane;
Cyclic siloxane 2: Decamethylcyclopentasiloxane;
Polysiloxane: 200 fluid methyl capped polydimethylsiloxane, 5 cSt (mm²/s) fluid (Dow).

Synthesis Example 1: The synthesis of an alkylsilyl group-containing cellulose, trimethylsilyl cellulose TMSC 1 was carried out as follows:

A 2CV Helicone mixer (Design Integrated Technology, Warrenton, VA) was purged with nitrogen. A mixture of cellulose pulp (20 g Cellulose 1) and ammonium chloride catalyst (0.33 g) was loaded into the mixer. Dimethyl sulfoxide (12 g) was then added to the mixer. The blades were started to mix the above components. Hexamethyldisilazane (39.8 g) was added slowly. Heating was started using an HTF System Heater/Chiller (Mokon, Buffalo, NY) and slowly increased to an internal temperature of 70° C. After one hour of heating at a 50 Hz blade speed, the contents of the mixer was cooled and the product collected through the bottom port of the mixer. The solid was washed with methanol, ground with a blender, washed two additional times with methanol, and dried in a vacuum oven at 100° C. overnight.

Synthesis Example 2: The synthesis of an alkylsilyl group-containing cellulose, trimethylsilyl cellulose TMSC 2 was carried out as follows:

The reaction was conducted in a 4CV Helicone Mixer (mixer) having a connected to the mixer sealed reactor pot equipped with an addition port and a bottom port. A nitrogen purge of the reactor pot was performed for 5-10 minutes before adding any reagents. The nitrogen flow was maintained for the duration of the experiment. 200 g of Cellulose 1 was added to the reactor pot, and mixing blades therein were started at 35 Hz. A fully dissolved solution of the NH₄Cl catalyst (6.6 g) in 75 g of dimethyl sulfoxide (DMSO) was added slowly to the reactor pot through a funnel; and the mixer contents were then mixed for 10 minutes at 50 Hz. 598.3 g hexamethyldisilazane was added over 10 minutes, and then the addition port was closed. The mixing speed was slowly increased to 75 Hz; and the reaction mixture was slowly heated to 90° C. The time of reaction after addition of all reagents was 60 minutes, stopping when reactor temperature reached 90° C. Then the temperature was set to 30° C. while keeping a mixing speed of 75 Hz. When the internal temperature decreased to 50° C., the product was transferred to a plastic storage container through a bottom port of the reactor pot. The product was washed with acetone, then allowed to dry overnight; and then was washed again with acetone, filtered, and dried for at least 1 day (24 hrs). The resulting material was ground using a blender.

Formulation Examples: The indicated TMSC was added into the indicated liquid silane and mixed by hand for a period of 5 minutes or until dissolved with a spatula and left to rest. Compositions were, as follows:

In Example 1, the composition comprised 98 wt. % of octyltriethoxy silane and 2 wt. % of the TMSC 1.

In Example 2, the composition comprised 98 wt. % of isobutyltriethoxy silane and 2 wt. % of the TMSC 1.

In Example 3, the composition comprised 98 wt. % of isobutyltriethoxy silane and 2 wt. % of TMSC 2.

Test Methods: In the following examples, the following test methods were used.

Beading effect: The efficiency of the indicated composition as a water repellent post treatment on the indicated substrate was assessed by looking at the shape of water droplets placed at the surface of the treated surface. A visual assessment of beading effect as a measure of the water repellent property of the construction material surface was scored from the scale in Table 1, below, based on the shape of the drops of water. After the indicated treated substrate was allowed to dry and condition for 20 days, a drop of 0.1 ml of water was placed on the substrate using a 1 ml pipette; and the drop was assessed to give a score according to the shape. The reported result, shown in Tables 2A and 2B, below, was an average of three (3) measurements for the indicated composition.

TABLE 1
Beading Effect Scale and the Shape and Score of Water Drops

| Rating | Observation |
|---|---|
| 1 | Excellent beading. High contact angle between water droplet and |
| | the substrate. Surface of the substrate does not darken. |
| 2 | Good beading. Medium contact angle between water droplet and |
| | the substrate. Surface of the substrate can darken somewhat. |
| 3 | Water droplet is not absorbed but slightly wet the surface of the |
| | substrate. Substrate is dark below the droplet |
| 4 | Water droplet is not absorbed but fully wets the surface of the |
| | substrate. Substrate becomes dark below the droplet |
| 5 | Water droplet is completely and quickly absorbed |

Gelation: The indicated compositions were gently mixed for 1 minute with a magnetic stirrer and then were tested by placing them in vials and letting them sit for 16 hours. Gelation was tested by a lack of flow in the absence of shear, for example, by turning over the vial. Thickening was measured by adding a 1 wt. %, 2 wt. % and 5 wt. % of TMSC, based on the total weight of the compositions, into the indicated silane.

Gelation results: In every case and at every amount, when the TMSC was added and stirred into a hydrolyzable organosilane, an immediate viscosity increase was observed. After being left overnight at room temperature, a dramatic increase of viscosity is observed in every case. The larger the TMSC content of the resulting composition, the larger the viscosity increase that was observed. After 16 hours of time gels were obtained with each of the 5 wt. % of TMSC in methyltrimethoxysilane, 2 wt. % with octyltriethoxysilane and 1 wt. % with the isobutyltriethoxysilane. Gels were obtained after 16 hours with all three silanes when Cellulose was added @ 5 wt. %. Gel was obtained with octyl triethoxysilane when cellulose was added @ 2 wt. % and only 1% was required when isobutyltrethoxysilane was used. The term “gel” as used herein, is defined as a paste which does not flow or which has some yield point, i.e. some applied force was needed to force flow or movement of the gelled material. When visually observed, the gels remained stable for two weeks at least.

Application Examples: The indicated gelled silanes were tested as a post water repellent treatment on cement substrates, including concrete and fiber cement boards. Gels were applied at the surface of the indicated substrate with a spatula. The quantity of gel applied was measured so as to amount to 100 g, 150 g or 200 g of gel/m² of substrates. To leave enough time to have the silanes to react with the cement or concrete matrix, the treated substrates were left to “cure” for a week before testing. A total of two substrates were tested and averaged per example. Results are reported in the water uptake and depth of penetration tests, below.

Tests on fiber cement boards and on concrete: Gelled silanes were tested as post treatment water repellent on the indicated substrates. Gels were applied to the surface of the substrates with a spatula in a quantity of gel measured at each of 100, 150 and 200 g of gel/m² of substrate. Treated substrates were allowed to cure for a week before testing, to leave enough time to have the silanes to react with the cement matrix.

Water uptake by capillary action from the untreated side (back side): The water penetration in a substrate treated with the indicated water repellent silane was tested 20 days after silane application by placing the back side (untreated surface) of the indicated substrate in contact with water. Capillary water absorption can lead to absorption of water throughout a substrate. However, ingress of the silane into the substrate is expected to prevent water penetration into at least a portion of the substrate thickness. Therefore, even if water is in contact with the back side of a given substrate, the test measures whether water no longer penetrates as deep into the substrate treated with the penetrating silane as it does into the same substrate left untreated. In accordance with the method, the indicated substrate having a thickness of 8 mm for fiber cement boards and 1.2 cm for concrete blocks was placed in a tank of water up to a depth of 2 to 5 mm, and resting on a thin water impervious aluminum support in the water. The water was absorbed by capillary action. After the indicated time periods, the substrates were removed from the water, quickly toweled to remove water other than water absorbed, then were weighed and replaced in the water. The percentage of water uptake was calculated in accordance with the following formula, wherein Wx: substrate weight after time in water in grams, and Wi: initial substrate weight:

$$\% Water uptake = ( Wx - Wi / ) Wi \times 100 \% .$$

An average of 3 different substrates were tested for each indication composition was reported. Results are shown in Table 4, below.

Depth of Penetration (DOP): To measure how deep a water repellent can penetrate within the structure of the indicated substrate, concrete blocks and fiber reinforced cement (FRC) sheets treated on one side only with the indicated composition and allowed to cure for 20 days. The substrates were broken in two after being in contact with water for 24 hours on the untreated side and then measured. Depth of penetration was determined by measuring with a caliper in three different points a dry zone which corresponds to the zone where the silane penetrated the cement matrix. Results are shown in Tables 3A and 3B, below.

TABLE 2A
Beading on Fiber Cement Board

| | | |
|---|---|---|
| Example 1 | Example 2 | Example 3 |

| | |
|---|---|
| Applied | Time>> |

| Quantity | 0 | 1 h | 0 | 1 h | 0 | 1 h |
|---|---|---|---|---|---|---|
| 100 g/m² | 1 | 1 | 1 | 2 | 1 | 2 |
| 150 g/m² | 1 | 1 | 1 | 2 | 1 | 2 |
| 200 g/m² | 1 | 1 | 1 | 2 | 1 | 2 |

As shown in Table 2A, above, all examples demonstrated a significant improvement on fiber cement boards with respect to the beading effect. In the control, beading on an untreated fiber cement board was rated as 3 at 0 hours and was rated a 5 after 20 min.

TABLE 2B
Beading on Concrete

| | | |
|---|---|---|
| Example 1 | Example 2 | Example 3 |

| | |
|---|---|
| Applied | Time>> |

| Quantity | 0 | 1 h | 0 | 1 h | 0 | 1 h |
|---|---|---|---|---|---|---|
| 100 g/m² | 1 | 1 | 1 | 1 | 1 | 1 |
| 150 g/m² | 1 | 1 | 1 | 1 | 1 | 1 |
| 200 g/m² | 1 | 1 | 1 | 1 | 1 | 1 |

As shown in Table 2B, above, all examples demonstrated a significant improvement with respect to beading effect, whereas beading on untreated concrete blocks did not occur. In the control, beading was rated as 4 at 0 hours and was rated 5 after 7 min.

TABLE 3A
Depth of penetration in 8 mm thick Cement Fiber Boards

| Applied Quantity | Example 1 | Example 2 | Example 3 |
|---|---|---|---|
| 100 g/m² | 3 mm | 4 mm | 3 mm |
| 150 g/m² | 3 mm | 4 mm | 4 mm |
| 200 g/m² | 3 mm | 4 mm | 4 mm |

As shown in a e, above, a fiber boards showed a significant improvement with respect to depth of penetration and significant reduction of water ingress. The test demonstrated that some significant layer of the boards were treated with the silane which could penetrate and treat the boards to a positive depth. In contrast, the untreated fiber board piece was fully wet after 24 h wetting in water.

TABLE 3B
Depth of penetration in 12 mm thick Concrete Blocks

| Applied Quantity | Example 1 | Example 2 | Example 3 |
|---|---|---|---|
| 100 g/m² | 4 mm | 4 mm | 4 mm |
| 150 g/m² | 5 mm | 5 mm | 4 mm |
| 200 g/m² | 6 mm | 6 mm | 4 mm |

As shown in Table 3B, above, all treated concrete examples demonstrated a significant improvement with respect to depth of penetration. In contrast, an untreated piece was fully wet after 24 h wetting in water.

TABLE 4
Capillary Water Uptake in Cement Fiber Boards

| | | Time (hours) | | | | | |
|---|---|---|---|---|---|---|---|
| EXAMPLE | Composition | 0 | 0.5 | 2.5 | 5.33 | 7.83 | 24.58 |
| 1* | Untreated | 0.00% | 2.56% | 4.09% | 4.28% | 4.33% | 4.41% |
| 2 | Example 1 @ 100 g/m² | 0.00% | 1.60% | 2.51% | 2.81% | 2.89% | 3.04% |
| 3 | Example 1 @ 150 g/m² | 0.00% | 1.54% | 2.37% | 2.48% | 2.52% | 2.63% |
| 4 | Example 1 @ 200 g/m² | 0.00% | 1.58% | 2.17% | 2.26% | 2.30% | 2.43% |
| 5 | Example 2 @ 100 g/m² | 0.00% | 2.25% | 3.25% | 3.44% | 3.50% | 3.63% |
| 6 | Example 2 @ 150 g/m² | 0.00% | 2.04% | 2.79% | 2.93% | 2.97% | 3.12% |
| 7 | Example 2 @ 200 g/m² | 0.00% | 1.00% | 1.57% | 1.70% | 1.78% | 1.93% |
| 8 | Example 3 @ 100 g/m² | 0.00% | 2.01% | 2.83% | 3.08% | 3.17% | 3.30% |
| 9 | Example 3 @ 150 g/m² | 0.00% | 2.33% | 2.99% | 3.11% | 3.18% | 3.30% |
| 10 | Example 3 @ 200 g/m² | 0.00% | 2.38% | 2.96% | 3.08% | 3.12% | 3.28% |

All of the Inventive Examples 2, 3, 4, 5, 6, 7, 8, 9, and 10 showed significant improvement with respect to capillary uptake by a cement fiber board having a thickness of 8 mm in comparison to the untreated cement fiber board, especially the Inventive Examples 2, 3 and 4 containing octyltriethoxy silane.

1. A composition suitable for use as a coating or a treating composition comprising:
one or more hydrolysable organosilanes comprising at least one hydrolysable group and at least one alkyl group or aryl group; and,
a rheology modifier comprising an alkylsilyl group-containing cellulose,
wherein the composition has viscosity at 25° C. of from 50 to 2000 centistokes (cSt or mm²/s.

2. The composition as claimed in claim 1, comprising:
from 90 to 99.9 wt. % in total of the one or more hydrolyzable organosilanes having a viscosity at 25° C. of from 0.2 to 20 cSt (mm²/s) and having a formula weight (FW) of from 89 to 500 g/mol; and,
from 0.1 to 10.0 wt. % of the alkylsilyl group-containing cellulose having a degree of alkylsilyl group substitution (DS) ranging from 0.8 to 3.0, and, further, having an average molecular weight of from 60 to 5,000 kDa, wherein all components add up to 100 wt. %.

3. The composition as claimed in claim 2, wherein at least one of the one or more hydrolyzable organosilanes comprises an alkoxy group.

4. The composition as claimed in claim 3, wherein at least one of the one or more hydrolyzable organosilanes is an alkoxyalkylsilane comprising one or more C₁ to C₁₂ alkyl groups and at least one alkoxy group.

5. The composition as claimed in claim 4, wherein the alkoxy group is a C₁ to C₄ alkoxy group.

6. The composition as claimed in claim 4, wherein the alkoxyalkylsilane is a methyl trimethoxysilane, an octyl triethoxysilane, an isobutyl triethoxysilane or a mixture thereof.

7. The composition as claimed in claim 1, wherein at least one of the one or more hydrolyzable organosilanes comprises two or more alkoxy groups.

8. The composition as claimed in claim 1, wherein the alkylsilyl group-containing cellulose has a degree of alkylsilyl group substitution (DS) ranging from 1.0 to 3.0.

9. The composition as claimed in claim 1, wherein the alkylsilyl group on the alkylsilyl group-containing cellulose comprises a silyl ether (Si—O—C) bond on any hydroxyl group of the cellulose, and the alkylsilyl group has the formula —Si(R¹)₃, wherein each R¹ group is independently chosen from an aryl group, hydrogen, or an alkyl group; and, further wherein, at least one R¹ group is other than hydrogen or an aryl group.

10. A method of coating or treating a cementitious substrate with the composition as claimed in claim 1, comprising applying the composition to the cementitious substrate.
